(19) United States
(12) Patent Application Publication
(10) Pub. No.: US 2005/0186390 A1
(43) Pub. Date: Aug. 25, 2005

(54) Z-pin closeout joint and method of assembly

(75) Inventors: Larry R. Bersuch, Fort Worth, TX (US); Patrick D. Sheahen, Fort Worth, TX (US)

Correspondence Address: James E. Bradley;Bracewell & Patterson, LLP, P.O. Box 61389, Houston, TX, 77208-1389, US

(73) Assignee: Lockheed Martin Corporation

(21) Appl. No.: 11/096,297

(22) Filed: Apr. 1, 2005

Related U.S. Application Data
(63) Continuation-in-part of application No. 10/212,339, filed on Aug. 5, 2002, now abandoned.

(51) Int. Cl. B32B 7/12

(52) U.S. Cl. 428/119; 156/92; 156/306.9

(57) ABSTRACT

A method uses a three-dimensional, adhesive-infused, woven preform to assemble two components, each component having z-pins extending from bonding surfaces. The components and preform are assembled with surfaces of the preform contacting surfaces of the components, the z-pins penetrating into the preform. The perform is equal or slightly greater in thickness than the protrusion lengths of the z-pins. The adhesive in the preform is then cured, adhering the preform to the components and retaining the z-pins within the preform.

### CROSS-REFERENCE TO RELATED APPLICATION

This application is a continuation-in-part of application Ser. No. 10/212,339, filed Aug. 5, 2002.

### FIELD OF THE INVENTION

This invention generally relates to assembly of components using woven preforms and particularly relates to assembly of components in closeout joints using adhesive-infused preforms.

### BACKGROUND OF THE INVENTION

Closeout panels can present problems for manufacturers, in that panels may attach to a substructure without access to the backside of the panel. In the past, these panels have been bolted to the substructure or attached using blind fasteners, such as pull rivets. These methods require expensive and time-consuming drilling and fastening operations and may weaken the structure: More recently, these panels have been co-bonded or secondarily bonded using resin or a thin layer of adhesive.

Typically, laminating resins are used as the matrix material in woven textiles, this also being true for woven preforms used to connect components made of composites or other materials. An example of a commonly used laminating resin is 977-3, available from Cytec Industries, Inc., of West Paterson, N.J. The laminating resin is infused into a textile product and is cured to form a polymer matrix in the finished composite component. When assembling a typical joint using a preform, the preform may be co-cured along with uncured composite components or the components may be cured prior to assembly using an uncured preform. Because of the inferior bonding characteristics of laminating resins, a thin layer of adhesive is often placed between the preform and the components. Generally, an adhesive film is used, which is expensive and adds to fabrication time.

To achieve proper bonding when using a thin layer of adhesive, such as an adhesive film, between pre-cured components, special attention must be paid to the interface at the adhesive layer. This bond line is critical, and, where two surfaces are brought together, the distance between the surfaces must be within a critical tolerance to ensure a proper bonding layer. The thickness of the adhesives is usually about 0.015″ thick with a bond layer tolerance of +/−0.005″. Methods for ensuring proper bonding may include tools, such as molds or vacuum bags, but particular applications may prevent the use of tools due to the inaccessibility of one or both sides of the joint. An example of this type of application is a closeout panel, such as the skin of a wing being bonded to an internal spar.

Z-pins have been used in joints connecting two composite, laminate components in the prior art. For example, U.S. Pat. Nos. 5,863,635, 5,968,639, and 5,980,665 to Childress discloses inserting z-pins into a first composite component to form stubble at a bonding face, then curing the first component. An uncured second component is then bonded to the first component with the stubble extending into and among the fibers of the second component and through the bond line.

As shown in FIG. 1 and in the '635, '639, and '665 patents, an additional prior-art method includes inserting a padup strip 11 between two cured components 13, 15. Components 13, 15 are generally formed of plies of woven or unidirectional fibers and a resin matrix and are cured with a Z-pin stubble extending from surfaces 17, 19. Padup strip 11, which is typically formed of the same materials as components 13, 15 or formed of a pure adhesive material without fiber reinforcement, is uncured during assembly. Components are assembled with padup strip 11 between surfaces 17, 19, the z-pin stubble fields extending into padup strip 11. The resin in padup strip 11 is then cured to co-bond the components 13, 15 to padup strip 11.

An alternative method of assembly using z-pins is disclosed in U.S. Pat. Nos. 5,876,540, 5,876,832, 5,935,698 to Pannell and shown in FIG. 2. A pre-cured strip 21 is formed of a plurality of plies of fibers and a resin matrix, a plurality of z-pins 23 extending from opposite sides of strip 21. Components 25, 27 are also formed of composites and may be cured or partially cured. To assemble partially cured components 25, 27, strip 21 is positioned between components 25, 27, then z-pins 23 are inserted into adjacent surfaces 29, 31. The resin in components 25, 27 is cured to co-bond surfaces 29, 31 and to retain z-pins 23 within components 25, 27. Alternatively, if components 25, 27 are pre-cured, padup strips 33 are used between strip 21 and surfaces 29, 31. Padup strips 33, like padup strip 11 in FIG. 1, are typically formed of the same materials as components 25, 27 or formed of a pure adhesive material without fiber reinforcement.

A need exists for an improved method that reduces the steps in assembly and provides for a strong joint when joining components using a woven preform. A further need exists for a method of joining components in a structural joint that provides for a larger dimensional tolerance between components when using an adhesive at the bond line.

### SUMMARY OF THE INVENTION

A method uses a three-dimensional, adhesive-infused, woven preform to assemble two components, each component having z-pins extending from bonding surfaces. The woven perform has a thickness at least equal to the sum of the lengths of the protruding portions of the z-pins. The components and preform are assembled with surfaces of the preform contacting surfaces of the components, the z-pins penetrating into the preform. The adhesive in the preform is then cured, adhering the preform to the components and retaining the z-pins within the preform. The adhesive may be cured at room temperature or through heat applied to the outer component. Alternatively, an electron-bearn may be used to cure the adhesive. Use of z-pins in the bond area and an adhesive, instead of a resin, creates a stronger joint, especially with fiber-reinforcement of the adhesive. The thickness of the compressible, three-dimensional weave provides for a larger dimensional tolerance at each bond line.

### BRIEF DESCRIPTION OF THE DRAWINGS

The novel features believed to be characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings.

FIG. 1 is an exploded, perspective view of a prior-art assembly using a padup strip and components having z-pin stubble.

FIG. 2 is a schematic sectional view of a prior-art assembly formed using a pre-cured strip to connect components, the pre-cured strip having z-pins extending from opposite sides.

FIG. 3 is an exploded, front view of an assembly of the present invention.

FIG. 4 is an exploded, front view of a second embodiment of an assembly of the present invention.

FIG. 5 is a schematic sectional view of the first and second components of the embodiment of FIG. 3 joined together.

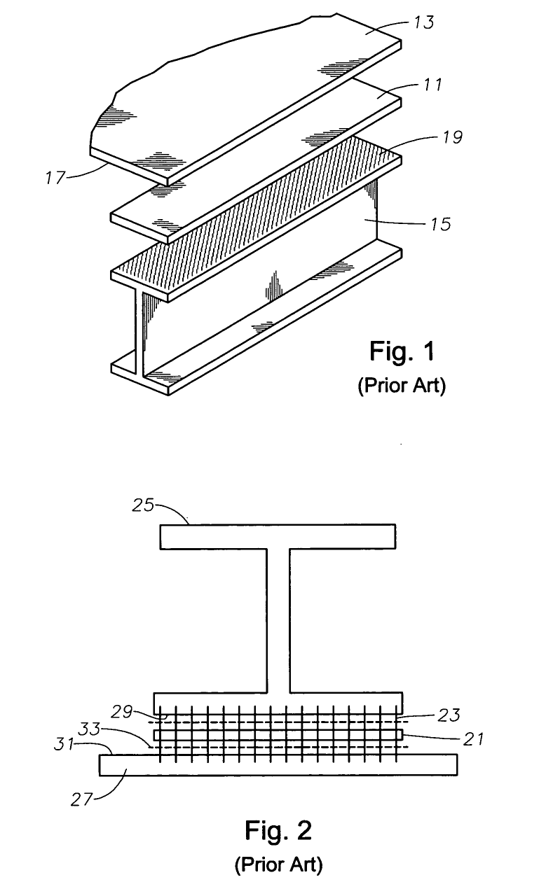

### DETAILED DESCRIPTION OF THE INVENTION

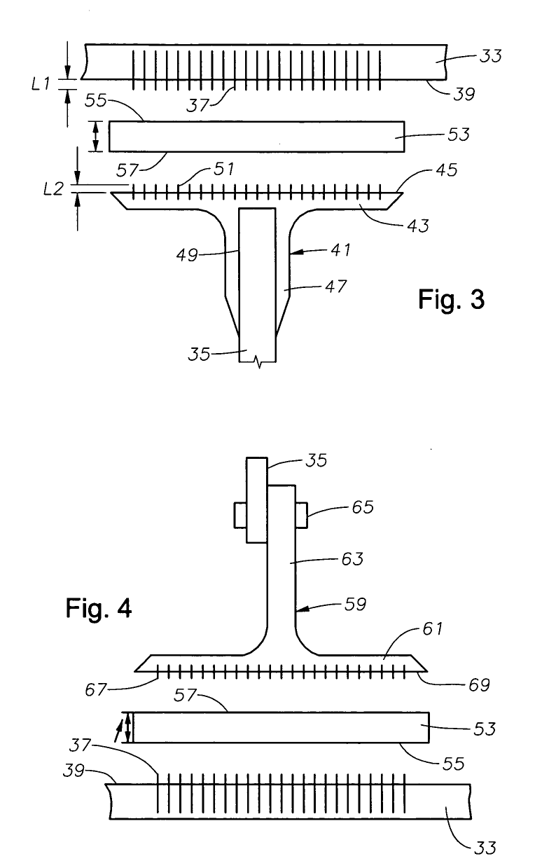

FIGS. 3 and 4 illustrate preferred embodiments of assemblies using an adhesive-infused, three-dimensional (3-D), woven textile preform used for assembling parts into structural joints. The preferred adhesive is FM® 300, also available from Cytec Industries, Inc., but other adhesives will work, providing the adhesive can be infused in a way that properly “wets out,” or saturates, the fiber bundles in the preform.

Various resin systems are sold under the terms “laminating resins” and “adhesives,” though there is no “bright-line,” industry-standard definition by which to distinguish one from the other. The term “adhesive,” as used herein, is meant as a resin system that has a lower modulus of elasticity and/or a higher strain-to-failure than the resin forming the matrix of the parts to be adhered. The combination of these characteristics is described as higher toughness, and adhesives have a higher toughness than laminating resins, which tend to be more brittle and have lower crack-formation loads.

Results from ASTM tests can be used to distinguish, generally, between laminating resins and adhesives. High-strength, structural laminating resins have a peel strength rating generally ranging up to 15 pounds per linear inch, whereas the peel strength of adhesives is greater than 15 pounds per linear inch. For example, the Bell Peel test (ASTM D3167 “Standard Test Method for Floating Roller Peel Resistance of Adhesives”) shows that the peel strength of FM® 300 adhesive is 23-29 pounds per linear inch at room temperature, but the peel strength of 977-3 laminating resin, which is used to laminate the parts, is up to 6 pounds per linear inch. In addition, laminating resins generally have a tensile strength greater than 7500 pounds per square inch (psi) as tested using ASTM D638 (“Standard Test Method for Tensile Properties of Plastics”), with high-strength resins ranging to 12000 psi. Adhesives generally have tensile strengths less than 6500 psi. Thus, in the present application, “adhesives” also means resin systems with tensile strengths less than 6500 psi and a peel strength greater than 15 pounds per linear inch. “Laminating resins” is used to mean resin systems having tensile strengths greater than 7500 psi and a peel strength of less than 15 pounds per linear inch.

To provide higher strain-to-failure characteristics, epoxy-based adhesives usually have rubber modifiers added to them. The higher strain capability improves load distribution through the preform, reducing the crack formation at the outer edges of the bond lines and in the weave that can lead to catastrophic failure of the joint at loads less than those which would cause failure of the parts. Also, adhesives usually have a higher viscosity than laminating resins. Laminating resins easily saturate woven components, whereas adhesives require an infusion process to wet-out the fiber bundles.

The preforms can be infused with adhesive in many ways. For example, one method is by hot-melt infusion, in which adhesive films are laid adjacent to the preform, and heat is applied to cause adhesive to wick into preform. Another method involves drawing preforms through a tank containing adhesive dissolved in a solvent, usually acetone or toluene. The preforms are immersed in the solution, then removed from the tank. The solvent is allowed to evaporate, or “flash off,” leaving the adhesive in the preform. To completely wet-out the preforms, this process may be repeated several times. The preform is saturated with the adhesive and is laid up while uncured. The parts, or components, to be joined may be formed from cured or partially cured composites or may be formed from other materials, e.g., plastics, metals, etc. Additional methods of infusion include resin-transfer molding (RTM) and vacuum-assist resin-transfer molding (VARTM).

Referring to the figures, FIG. 3 shows an exploded assembly for connecting components 33, 35, such as planar closeout panel 33, which may be, for example, an outer skin of an aircraft wing, and planar spar 35. Panel 33 is a cured, fiber-reinforced composite having a plurality of z-pins 37 inserted through bonding surface 39 prior to curing of panel 33. Z-pins 37 are inserted using any appropriate technique and are arranged in a selected pattern, z-pins 37 preferably being normal to surface 39. The number of z-pins 37 is selected to provide a desired areal density of z-pins 37 relative to the area of surface 39. Curing of panel 33 affixes z-pins 37 in the matrix of panel 33. Spar 35 may be formed of any rigid material, such as composites or metal.

A cured, pi-shaped, woven preform 41 is bonded to spar 35, preform being woven from fibers using a three-dimensional (3-D) weave pattern. Preform 41 preferably has a matrix formed form laminating resin. Preform 41 has a base 43 having a continuous bonding surface 45, and a pair of spaced-apart legs 47 extend vertically from base 43. Each leg 47 is at a position that is offset from, but near to, the center of base 43. In this embodiment, legs 43 are parallel to each other and generally perpendicular to base 43. In the installed position, the inner surfaces of legs 47 face each other to form a slot 49 for receiving spar 35. A plurality of z-pins 51 are inserted into base 43 through bonding surface 45 prior to curing of preform 41. The pattern and areal density of z-pins 51 are preferably approximately the same as those for z-pins 37 in panel 33. Preform 41 may be secondarily bonded to spar 35 after curing of preform 41 or may be co-bonded to spar 35. Alternatively, if spar 35 is formed from composites, spar 35 and preform 41 may be co-cured.

An adhesive-infused, woven preform 53 has a rectangular cross-section and opposed bonding surfaces 55, 57 and is woven using a 3-D weave pattern to have a selected thickness t. Preform 53 is used to connect panel 33 to preform 41 by bonding surface 39 of panel 33 to surface 55 and surface 45 of preform 41 to surface 57. Preform 53 preferably has at least two warp-fiber layers and thickness t of about 0.050″-0.060″ or may have additional layers, providing an increased thickness t.

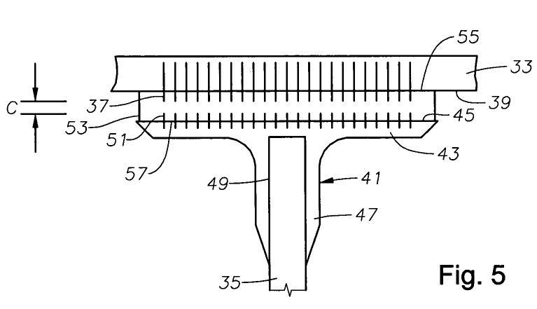

Z-pins 37 protrude substantially the same length L1 from bonding surface 39. Z-pins 51 protrude approximately the same length L2 from bonding surface 45. In the preferred embodiment, protrusions lengths L1 and L2 are equal to each other, however, they could differ. Preferably, thickness t of perform 53 at least equals the sum of protrusion lengths L1 and L2. Preferably, for a thickness t of 0.060″, protrusion lengths L1 and L2 are each slightly less than 0.030″. In the example shown, thickness t is shown an exaggerated amount greater than the sum of protrusion lengths L1 and L2. Consequently, after components 33 and 43 are joined, as shown in FIG. 5, a clearance c exists between the ends of z-pins 37 and 51.

Z-pins 37 are spaced quite closer to each other, typically being only about 1/10″ apart from each other. Similarly, z-pins 51 are closely spaced to each other. Making the thickness of woven perform 53 at least equal to the protrusion lengths L1, L2 avoids the ends of some of z-pins 37 striking some of the ends of z-pins 51. If z-pins 37 strike and interfere with z-pins 51, components 33 and 43 possibly may not move into tight engagement with the opposite sides of perform 53.

As surfaces 39, 55 and 45, 57 are moved toward each other, Z-pins 37, 51 penetrate preform 53 until surfaces 39, 55 and 45, 57 contact each other, the length of z-pins 37, 51 being less than thickness t of preform 53. Bond layers form at the interfaces of surfaces 39, 55 and 45, 57, connecting panel 33 to preform 41, which is bonded to spar 35. Because the adhesive is infused in preform 53 having selected thickness t, the bond layer dimensional tolerance is increased, preform 53 allowing for a larger variation in distance between surfaces 39, 45. Without preform 53, the distance between surfaces 39, 45 must be within a critical tolerance to ensure a proper bonding layer. Additionally, use of preform 53 allows for some misalignment of panel 33 in relation to preform 41 when bonding and can accommodate dimensional variations in surfaces 39, 45.

Mechanical pressure is all that is required to push panel 33 towards preform 41 during curing, compressing preform 53 and ensuring continuous bondlines between surfaces 39, 55 and 45, 57. If the adhesive is a heat-cured adhesive, heat is applied to the outer surface of panel 33 to cause the rapid curing of the adhesive. Alternatively, adhesives used in preform 53 may be cured by other types of cure mechanisms, for example, electron-beam curing.

During assembly, panel 33 and preform 41 are fabricated to desired dimensions and shapes, then z-pins 37, 51 are inserted prior to curing of panel 33 and preform 41. Preform 41 may be bonded to spar 35 during or after curing of preform 41. Preform 53 is fabricated to have a selected thickness t, then infused with an adhesive. Preform 53 is positioned between panel 33 and base 43 of preform 41, then panel 33 is moved toward preform 41, with z-pins 37, 51 penetrating preform 53. Panel 33 is moved toward preform 41 until surface 39 contacts surface 55 of preform 53 and surface 45 contacts surface 57, then mechanical pressure is applied to the outer surface of panel 33 for compressing preform 53 during curing of the adhesive.

When fabricating preform 53, thickness t may be increased to ¼″ or beyond and may involve the use of thicker fibers. However, the weight of the extra adhesive used in a thicker preform would likely mean that thicker preforms would be reserved for applications where minimization of weight is not a primary concern, for example, in construction of boats.

FIG. 4 illustrates a second assembly using preform 53 to connect panel 33 to a cured woven preform 59. T-shaped preform 59 has a base 61 and a generally perpendicular leg 63 extending from base 61. Preform 59 is connected to spar 35 with fastener 65, which may be of any appropriate type, or preform 59 may be bonded to spar 35. Prior to curing of preform 59, z-pins 67 are inserted into base 61 through bonding surface 69 in a desired pattern having a selected areal density, the pattern and density preferably being approximately the same as those for z-pins 37 in panel 33. As in the previously described assembly, the multi-layered, rectangular cross-section of preform 53 allows for a larger dimensional tolerance between panel 33 and preform 59.

During assembly, panel 33 and preform 59 are fabricated to desired dimensions and shapes, then z-pins 37, 67 are inserted prior to curing of panel 33 and preform 59. Preform 59 is fastened to spar 35 using fastener 65. Preform 53 is fabricated to have a selected thickness t, then infused with an adhesive. Preform 53 is positioned between panel 33 and base 61, then panel 33 is moved toward preform 59, with z-pins 37, 67 penetrating preform 53. Panel 33 is moved toward preform 59 until surface 39 contacts surface 55 of preform 53 and surface 69 contacts surface 57, then mechanical pressure is applied to the outer surface of panel 33 for compressing preform 53.

The advantages of the present invention include the increased strength from the addition of z-pins in the bond area and using an adhesive, rather than a resin, within a 3-D woven preform used to connect components. Another advantage is the reduction of steps needed to complete the assembly. By infusing the adhesive into preforms, pieces can be joined without the need for a separate adhesive film being inserted between a resin-infused connector and the pieces to be joined. Also, the thickness of the preform allows for a larger dimensional tolerance at the bond line, while providing the strength of fiber-reinforced adhesive. Making the thickness of the perform equal or greater than the protrusion lengths of the z-pins assures that the z-pins from one component do not strike the z-pins from the other component.

While the invention has been shown in only some of its forms, it is not thus limited but is susceptible to various changes and modifications without departing from the spirit thereof.

1. A method for bonding a first component to a second component, the method comprising:
(a) providing each of the components with a bonding surface having a plurality of z-pins extending therefrom;
(b) providing an adhesive preform having a selected thickness that is at least equal a sum of each of the lengths that the z-pins protrude from first and second components, the adhesive preform being formed of fibers woven in a three-dimensional weave pattern;
(c) infusing the adhesive preform with an adhesive;
(d) assembling the adhesive preform and the first component, a first surface of the adhesive preform contacting the bonding surface of the first component, the z-pins of the first component penetrating the adhesive preform through the first surface;
(e) assembling the adhesive preform and the second component, a second surface of the adhesive preform contacting the bonding surface of the second component, the z-pins of the second component penetrating the adhesive preform through the second surface; and
(f) curing the adhesive in the adhesive preform to adhere the first and second components to the adhesive preform and to retain the z-pins within the preform.

2. The method of claim 1, wherein:
the adhesive has a tensile strength less than 6500 pounds per square inch.

3. The method of claim 1, wherein:
the adhesive has a peel strength greater than 15 pounds per linear inch.

4. The method of claim 1, wherein:
step (e) comprises applying mechanical pressure during curing.

5. The method of claim 1, wherein:
the adhesive preform is free of resin.

6. The method of claim 1, wherein:
the adhesive preform has a rectangular cross-section.

7. The method of claim 1, wherein:
the adhesive preform has a thickness of at least two textile layers.

8. The method of claim 1, wherein:
the second component comprises a structural member and a resin-infused preform formed of fibers woven in a three-dimensional weave pattern; and the method further comprising
inserting the z-pins of the second component into the resin-infised preform.

9. The method of claim 1, wherein:
the second component comprises a structural member and a resin-infused preform formed of fibers woven in a three-dimensional weave pattern; and the method further comprising
inserting the z-pins of the second component into the resin-infused preform; and
joining the resin-infused preform to the structural member.

10. The method of claim 1, wherein:
the second component comprises a structural member and a resin-infused preform formed of fibers woven in a three-dimensional weave pattern; and the method further comprising
inserting the z-pins of the second component into the resin-infused preform; and
bonding the resin-infused preform to the structural member during curing of the resin-infused preform.

11. A method for bonding components at adjacent planar surfaces, the method comprising:
(a) providing a first component with a bonding surface and a plurality of z-pins extending from the bonding surface a first length;
(b) providing a resin-infused preform with a bonding surface and a plurality of z-pins extending from the bonding surface a second length that is substantially the same as the first length;
(c) providing an adhesive preform having a thickness at least equal to the sum of the first and second lengths and opposing bonding surfaces, the adhesive preform being formed of fibers woven in a three-dimensional weave pattern;
(d) infusing the adhesive preform with an adhesive;
(e) assembling the adhesive preform and the first component, one of the bonding surfaces of the adhesive preform contacting the bonding surface of the first component, the z-pins of the first component penetrating the adhesive preform through the first surface;
(f) assembling the adhesive preform and the resin-infused preform, the other of the bonding surfaces of the adhesive preform contacting the bonding surface of the resin-infused preform, the z-pins of the resin-infused preform penetrating the adhesive preform through the second surface;
(g) curing the adhesive in the adhesive preform to adhere the first component and the resin-infused preform to the adhesive preform and to retain the z-pins within the preform; and
(h) joining the resin-infused preform to a structural member.

12. The method of claim 11, wherein:
step (h) comprises curing resin in the resin-infused preform to bond the resin-infused preform to the structural member.

13. The method of claim 11, wherein:
step (h) comprises curing resin in the resin-infused preform prior to fastening the resin-infused preform to the structural member.

14. A structural joint, comprising:
a first component having a bonding surface and a plurality of z-pins extending from the bonding surface a first length;
a second component having a bonding surface and a plurality of z-pins extending from the bonding surface a second length;
an adhesive preform having a thickness at least equal to the sum of the first and second lengths, the adhesive preform being formed of fibers woven in a three-dimensional weave pattern and infused with an adhesive; and wherein
the adhesive preform is adhered to the first component using the adhesive in the adhesive preform, a first surface of the adhesive preform being adjacent the bonding surface of the first component, the z-pins of the first component extending into the adhesive preform through the first surface; and
the adhesive preform is adhered to the second component using the adhesive in the adhesive preform, a second surface of the adhesive preform being adjacent the bonding surface of the second component, the z-pins of the second component extending into the adhesive preform through the first surface.

15. The joint of claim 14, wherein:
the adhesive preform is free of resin.

16. The joint of claim 14, wherein:
the adhesive preform has a rectangular cross-section.

17. The joint of claim 14, wherein:
the adhesive preform has a thickness of at least two textile layers.

18. The joint of claim 14, wherein:
the second component comprises a structural member and a resin-infused preform formed of fibers woven in a three-dimensional weave pattern, the z-pins of the second component being inserted into the resin-infused preform.

19. The joint of claim 14, wherein:
the second component comprises a structural member and a resin-infused preform formed of fibers woven in a three-dimensional weave pattern, the z-pins of the second component being inserted into the resin-infused preform; and
the resin-infused preform is fastened to the structural member after curing of the resin-infused preform.

20. The joint of claim 14, wherein:
the second component comprises a structural member and a resin-infused preform formed of fibers woven in a three-dimensional weave pattern, the z-pins of the second component being inserted into the resin-infused preform; and
the resin-infused preform is bonded to the structural member during curing of the resin-infused preform.
